(19) United States
(12) Patent Application Publication
(10) Pub. No.: US 2011/0157099 A1
(43) Pub. Date: Jun. 30, 2011

(54) Liquid Crystal Display Panel and the Inspection Method thereof

(75) Inventor: Xiao-Lin WANG, SUZHOU (CN)

(73) Assignees: AU OPTRONICS (SUZHOU) CORP., LTD., SUZHOU (CN); AU OPTRONICS CORPORATION, HSIN-CHU (TW)

(21) Appl. No.: 12/976,824

(22) Filed: Dec. 22, 2010

(30) Foreign Application Priority Data
Dec. 28, 2009 (CN) 200910261136.7

(51) Int. Cl. G06F 3/041; G09G 3/36

(52) U.S. Cl. 345/178; 345/173; 345/92

(57) ABSTRACT

The present invention provides a liquid crystal display (LCD) panel, comprising: a plurality of scan lines, data lines and sense lines, display cells and sensor elements. Each sensor element includes a first bottom electrode, a thin film transistor (TFT), a second bottom electrode, and a switch. When the switch is pressed down, the first bottom electrode is electrically connected to the second bottom electrode. The present invention also provides an inspection method for touching the above-mentioned LCD panel, comprising: opening one of the scan lines; electrically connecting the pixel electrode with an inspection circuit; comparing the input voltage to the threshold voltage, while the inspection circuit sends a control signal, representing that the display cell has been pressed.

### RELATED APPLICATIONS

This application claims priority to China Application Serial Number 200910261136.7, filed Dec. 28, 2009, which is herein incorporated by reference.

### FIELD OF INVENTION

The present invention relates to a liquid crystal display (LCD) panel. More particular, the present invention relates to an LCD panel having both functions of press inspection and image display.

### BACKGROUND ART

Currently, with development of the semiconductor technology and the fabrication process, the thin film transistor liquid crystal display (TFT-LCD) has been widely used in various fields because of its high quality, low power consumption, little radiation and light weight.

The LCD panel typically includes: an array substrate, a color filter substrate, and a liquid crystal molecules layer interposed between the array substrate and the color filter substrate. In detail, a plurality of pixels is located on the array substrate, which is defined as the intersection point of the data line and corresponding scan line. And these pixels are driven by the pixel driver circuit consisting of the electronic components. Usually, the color filter substrate is a transparent glass substrate, on which the transparent conductive film layer is formed of sputtering the materials such as ITO or IZO. Such transparent conductive film layer (as common electrode) electrically connects to the common electrode source, together with the corresponding pixel electrode across the array substrate to generate the predetermined voltage, and thereby to control the twist of the liquid crystal molecules.

Illustrating the touch panel as an example, in the prior art, a photo spacer is generally designed to locate on the color filter substrate, and the photo spacer protrudes towards the orientation of the array substrate. Also, a transparent conductive film layer, such as ITO layer, is sputtered on the photo spacer's surface and the total surface of the color filter substrate. When the user presses the touch screen, the ITO layer on the photo spacer electrically connects to the sensor on the array substrate. Thus, the display cell of the LCD panel may be inspected to have been pressed down according to the voltage signal from the sensor. Otherwise, when the user does not press the touch screen, the ITO layer on the photo spacer keeps disconnecting to the sensor in the array substrate.

However, in the above described LCD panel, both the surfaces of the color filter substrate and the photo spacer are sputtered a continuous transparent conductive film layer, so that the voltage level achieved from the sensor is approximately equal to the voltage level of the color filter substrate, when the display cell is pressed. That is, the sidewall of the photo spacer must be coated with the ITO conductive layer, and it will lead to some problems about the stability and complexity of the fabrication process. Further, when the color filter substrate electrically connects to the common power source, the system has to supply the direct current (DC) power, and thereby the system power consumption increases. Once the alternative current (AC) power is loaded, if we press the LCD panel, then the sensor will be conductive to the ITO layer in the color filter substrate via the photo spacer, and thus the sensor has an instable voltage.

### SUMMARY OF THE INVENTION

Aiming at the above-described defects regarding the conventional techniques for the usage of the LCD panel, the present invention provides a new LCD panel, and also provides an inspection method with respect to such panel.

In one aspect, the present invention is directed to an LCD panel, which comprises: a plurality of scan lines, a plurality of data lines, a plurality of sense lines, a plurality of pixel units. The data lines are arranged to perpendicularly intersect across the scan lines, and the sense lines are arranged to be parallel to the data lines. Each of pixel units comprises a display cell and a sensor element, wherein the display cell is electrically connected with one scan line and one data line, and the sensor element comprises a first sensing electrode, a thin film transistor, a second sensing electrode, and a switch element. The thin film transistor comprises a gate electrode electrically connected to the scan line connected with the display cell; a first electrode electrically connected to one sense line; and a second electrode electrically connected to the first sensing electrode. The second sensing electrode is arranged on the same plane together with the first sensing electrode, and the second sensing electrode and the first sensing electrode separate from each other. And the switch element is arranged over the first and second sensing electrodes, wherein the switch element electrically connects the first sensing electrode with the second sensing electrode when the switch element is pressed to touch the first and second sensing electrodes.

In one embodiment, the switch element is a conductive material layer disposed on the top surface of a photo spacer and the photo spacer is disposed on a first substrate opposite to a second substrate having the thin film transistor thereon. Preferably, the conductive material layer is a transparent material of ITO or IZO. Preferably, the conductive material layer is electrically insulated to a common electrode disposed on the first substrate.

In another embodiment, the second sensing electrode is electrically connected to a storage capacitance bottom electrode or a next scan line adjacent to the sensor element.

In a further embodiment, the first sensing electrode is a low-level voltage when the switch is pressed down.

In another aspect, the present invention is directed to an LCD panel, which comprises: a plurality of scan lines, a plurality of data lines, a plurality of display pixel cells, an inspection circuit and a switch. The data lines are arranged to perpendicularly intersect across the scan lines. Each of the display pixel cells comprises a sensing bottom electrode, a display electrode, a thin film transistor and a sensing conductive layer, wherein the sensing bottom electrode is electrically connected to a reference power source; the display electrode is arranged on the same plane together with the sensing bottom electrode, and the display electrode and the sensing bottom electrode separate from each other; the thin film transistor comprises a gate electrode electrically connected to one scan line and a first electrode electrically connected to one data line and a second electrode electrically connected to the display electrode; and the sensing conductive layer disposed over the sensing bottom electrode and the display electrode. And the sensing conductive layer electrically connects the sensing bottom electrode and display electrode when the sensing conductive layer is pressed down to touch the sensing bottom electrode and display electrode. The inspection circuit is used to inspect the voltage of the display electrode; and a switch is electrically connecting to the data line for handing over the first electrode electrically connecting to the inspection circuit through the data line, and when the display signal is written into the display electrode, the switch connects the first electrode with a data driving circuit.

In one embodiment, the sensing conductive layer is made of transparent conductive materials. Moreover, the transparent conductive material is ITO or IZO.

In another embodiment, the sensing conductive layer is located on the top surface of a photo spacer and the photo spacer is disposed on a first substrate opposite to a second substrate having the thin film transistor thereon. Preferably, the sensing conductive layer is insulated to a common electrode disposed on the first substrate.

In a further embodiment, the display electrode is the reference voltage level when the sensing conductive layer is pressed down.

In yet further embodiment, the inspection circuit comprises a voltage comparator. Preferably, a first input terminal of the voltage comparator connects to the display electrode via the switch, and a second input terminal of the voltage comparator electrically connects to a reference voltage. In addition, the inspection circuit further comprises a resistor, disposed between the first input terminal and the switch.

In one embodiment, the LCD panel further comprises a resistor arranged between the inspection circuit and the switch.

In another aspect, the invention provides an inspection method for the LCD panel comprising a resistor arranged between the inspection circuit and the switch. The method comprises: opening the scan line linking to the gate electrode, and handing over the switch to connect the display electrode with the inspection circuit; and transmitting electrical signal of the display electrode to the inspection circuit, wherein the inspection circuit sends out a control signal representing that the display cell has been pressed and the sensing conductive layer electrically connects the display electrode to the sensing bottom electrode, when the electrical signal of the display electrode is derived from the reference power source.

In one embodiment, the electrical signal is a current signal.

In another aspect, the invention provides an inspection method for touching the LCD panel. The method comprises: opening the scan line linking to the gate electrode, and handing over the switch to connect the display electrode with the inspection circuit; and transmitting a voltage signal of the display electrode to the inspection circuit, wherein the inspection circuit sends out a control signal representing that the display cell has been pressed and the sensing conductive layer electrically connects the display electrode to the sensing bottom electrode, when the voltage signal of the display bottom electrode is derived from the reference power source.

### BRIEF DESCRIPTION OF THE DRAWINGS

These and other features of the invention will become more apparent from the following description, in which reference is made to the appended drawings, wherein:

FIG. 1 is an exemplary structure diagram illustrating the LCD panel according to one aspect of the invention;

FIG. 2A illustrates one state of the structure when the LCD panel in FIG. 1 has not been pressed, while FIG. 2B illustrates another state as such LCD panel has been pressed;

FIG. 3 is an exemplary structure diagram illustrating the LCD panel according to another aspect of the invention;

FIG. 4 is a circuit schematic diagram of implementing the press inspection and image display in the LCD panel of FIG. 3; and FIG. 4A illustrates the exemplary inspection circuit of the circuit schematic diagram of FIG. 4;

FIG. 5 is a flow chart of a first embodiment of performing the press inspection by the inspection circuit of FIG. 4A; and

FIG. 6 is a flow chart of a second embodiment of performing the press inspection by the inspection circuit of FIG. 4A.

### DETAILED DESCRIPTION OF THE INVENTION

One or more currently preferred embodiments have been described by way of example. It will be apparent to the skilled in the art that a number of variations and modifications can be made without departing from the scope of the invention as defined in the claims.

Seen from the screen function of the LCD panel, all TFT-LCD panels may be substantially divided into two types: contact-based panels and noncontact-based panels. For the contact-based panels, the user may directly touch the certain position in the screen, so that the system receives the response information and executes various operations. As a result, it is a more convenient and comfortable experience. During this interaction, the LCD panel should inspect and determine if the panel is pressed, besides that it displays the image in some display cells by controlling the scan lines and the data lines.

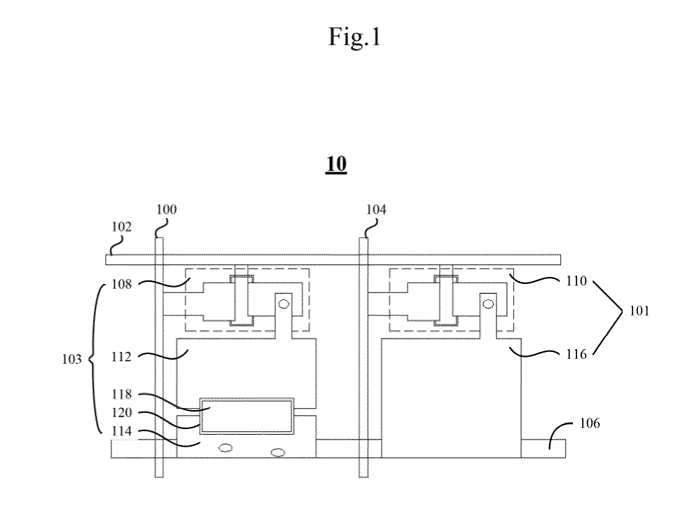

FIG. 1 is an exemplary structure diagram illustrating the LCD panel according to one aspect of the invention.

An LCD panel includes a plurality of pixel cells 10, each pixel cell 10 includes a sense line 100, a scan line 102, a data line 104, a scan line or a common line 106, a readout TFT 108, a display TFT 110, display electrodes 112, 114 and 116, a conductive layer 118 and a photo spacer 120. The pixel cell 10 includes a display cell 101 and a sensor cell 103, the display cell includes the display TFT 110 and display electrode 116 and the sensor cell 103 includes readout TFT 108, display electrodes 112, 114, a conductive layer 118 and a photo spacer 120.

In a similar way, the gate electrode of TFT 110 is electrically connected to the scan line 102, the source electrode of TFT 110 is electrically connected to the data line 104, and the drain electrode of TFT 110 is electrically connected to the display electrode 116. It should be understood that, TFT 110 is used to display image, and here the relevant description is omitted.

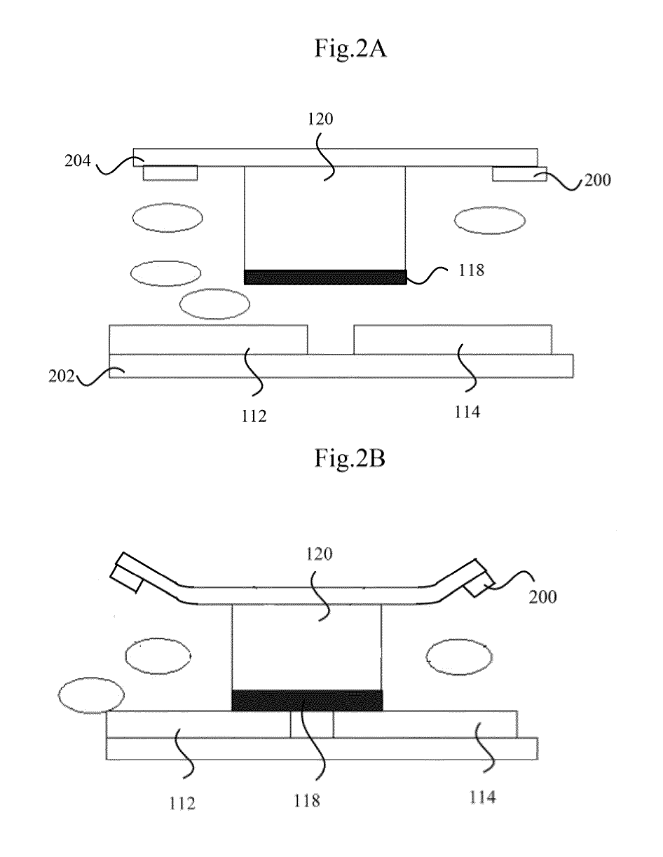

The gate electrode of TFT 108 is electrically connected to the scan line 102, the source electrode of TFT 108 is electrically connected to the sense line 100, and the drain electrode of TFT 108 is electrically connected to the display electrode 112. As described above, the readout TFT 108 and display TFT 110 are disposed on the array substrate, and the liquid crystal molecules are located between the array substrate 202 and an opposite substrate 204, which is opposite to the array substrate 202, referring to FIG. 2A. The photo spacer 120 is on the opposite substrate 204, and its bottom surface is in contact with the opposite substrate, while its top surface protrudes towards the array substrate and does not contact with the array substrate. The conductive layer 118 is on the top surface of the photo spacer 120. When the pixel cell 10 is pressed down, the display electrodes 112 and 114 electrically connect together through the conductive layer 118. In this embodiment, the conductive layer 118 serves as a circuit path linking the display electrode 112 and the display electrode 114. Therefore, unlike the conventional techniques, it must be electrically connected to the common electrode and the transparent conductive film layer must be formed on the sidewall of the photo spacer. In this embodiment, since the display electrode 114 connects with the scan line 106, then the pixel cell 10 will be determined to appear in pressed state when the display electrode 112 positioned on the sensor cell 103 is inspected at a low voltage level. It should be understood by the skilled in the art, the respective source electrode and drain electrode of TFT 108 and TFT 110 are interchangeable. For example, the drain electrode of TFT 108 may also connect with the sense line 100, and the source electrode of TFT 108 connects with the display electrode 112. It should be further understood that, the display electrode 114 is not restricted to electrically connect to the scan line 106 adjacent to the scan line 102, it may connect with a reference power source, such as the storage capacitance bottom electrode of the pixel cell 10. In other words, when the voltage level from the sensor of the display electrode 112 is equal to that of the display electrode 114, it means that the display cell has been pressed.

FIG. 2A is an exemplary diagram illustrating the state when the LCD panel as shown in FIG. 1 has not been pressed, while FIG. 2B illustrates the state of such LCD panel having been pressed. In FIG. 2A, only a patterned transparent conductive film layer 200 is sputtered on the part of the surface of the opposite substrate 204, and the transparent conductive film layer 200 is connected to the common electrode, to load the common voltage VCOM. The photo spacer 120 is formed on the opposite substrate, and the conductive layer 118 is disposed on the top surface of the spacer. The transparent conductive film layer 200 and the conductive layer 118 are made of a transparent material such as ITO or IZO. It should be emphasized that, ITO conductive layer 118 is only needed to form on the top surface of the photo spacer 120 rather than the sidewall. Thus, the climbing ability of ITO material, which is formed on the sidewall of the photo spacer 120, is no longer a specific requirement, so that the fabrication process will be increasingly simplified. When the pixel cell 10 is not pressed, the display electrode 112 and display electrode 114 stay in an electrically insulation state, and the voltage inspected by the sensor cell 103 will have no change.

When the pixel cell 10 is pressed, as shown in FIG. 2B, the photo spacer 120 moves towards the array substrate 202, so that the display electrode 112 electrically connects to the display electrode 114 via the conductive layer 118. As the display electrode 114 connects to the scan line 106 (FIG. 1), when the scan line 102 is enabled to open the readout TFT 108 and display TFT 110, the scan line 106 remains a low voltage level. Therefore, the display electrode 112 electrically connecting to the display electrode 114 also remains the low voltage level. As a result, we can determine if the pixel cell 10 is pressed by inspecting the voltage of the display electrode 112 of the sensor cell 103 in real time. It should be understood by the skilled in the art, the conductive layer 118 on the top surface of the photo spacer 120 is electrically connected to the display electrodes 112 and 114 when the pixel cell 10 is pressed. That is, once a reference power source is provided to connect with the display electrode 114, whether the pixel cell 10 is pressed can be inspected by the display electrode 112 of the sensor cell 103. For such consideration, the display electrode 114 is not limited to electrically connect to the next scan line 106, and it may also connect to the other reference power source, such as the common electrode.

In the LCD panel of FIG. 1, the conductive layer 118 on the top surface of the photo spacer 120 serves as a switch, and the display electrodes 112 and 114 are electrically connected by use of the conductive layer 118. In the sense, the realization that display electrodes 112 and 114 are electrically connected or electrically insulated is not limited to use the photo spacer 120. Since the display electrode 114 is connected to the scan line 106, we can determine that the pixel cell 10 is pressed according to the voltage (i.e., low voltage level) from the sensor on the display electrode 112. Comparatively, the prior art not only requires sputtering an ITO transparent conductive layer on the total surface of the opposite substrate, but requires sputtering the ITO transparent conductive layer on the sidewall and top surface of the photo spacer, and thereby the fabrication process is very complex.

As the conductive layer 118 is insulated with the common electrode 200 of the opposite substrate, the voltage inspected by the sensor on the display electrode 112 is not correlated to the common voltage VCOM, so the common electrode power source in the system is unnecessary to restrain as a direct current (DC) drive mode, for example, it may also use an alternative current (AC) drive mode, to reduce the power consumption. In addition, the display electrode linking with the readout TFT 108 is divided into display electrode 112 and display electrode 114, which will improve the pixel aperture ratio of the panel.

The above illustrates one embodiment of the LCD panel according to the invention. In the LCD panel of FIG. 1, display TFT 110, data line 104, display electrode 116, scan lines 102 and 106 are used to control the display cell 101 to display the image in different gray scales; while the readout TFT 108, sense line 100, display electrodes 112 and 114, conductive layer 118, photo spacer 120 and scan lines 102 and 106 are used to inspect whether the pixel cell 10 has been pressed. Here, the display TFT and the readout TFT respectively perform the pixel display and the press inspection, and they are substantially driven and controlled by individual structures. Thus, the LCD panel needs to increase the additional sense lines and a plurality of readout TFTs, inspecting whether the pixel is pressed and displays the image in different gray scales.

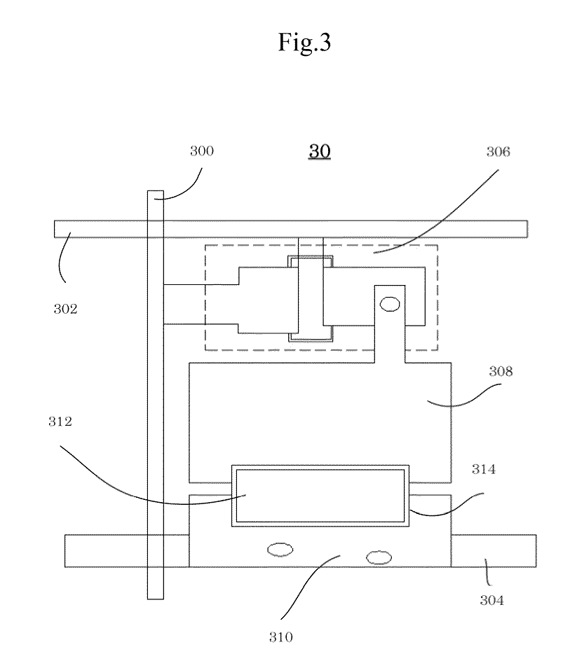

In another embodiment of the LCD panel of the invention, FIG. 3 illustrates an exemplary structure of LCD panel. The LCD panel includes a plurality of pixel cells 30, each pixel cell 30 includes a data line/sense line 300, a scan line 302, a next scan line 304 adjacent to scan line 302, a readout/display TFT 306, two display electrodes 308 and 310, a conductive layer 312, and a photo spacer 314. Unlike the LCD panel 10, the data lines and sense lines of the LCD panel utilizes a multiplex design, and the readout TFT and the display TFT are also designed as a multiplex structure. When the switch of the LCD panel (not shown) remains iii an open state or a closed state, the source electrode (or drain electrode) of the TFT correspondingly connects to the inspection circuit or the data driver.

The conductive layer 312 is disposed over the display electrodes 308 and 310, where the display electrode 308 is normally insulated to the display electrode 310. When the photo spacer 314 is pressed, one part of the conductive layer 312 contacts with the display electrode 308, and the other part contacts with the display electrode 310. Thus, the connection relationship between the display electrodes 308 and 310 transforms the electrical insulation state to the electrical conductive state through the conductive layer 312. Preferably, the display electrode 310 is electrically connected to the scan line 304. And when the pixel is pressed, the display electrode 308 remains a low level voltage, and thereby we can determine that the pixel has been pressed by inspecting the voltage level of the display electrode 308. In this embodiment, the conductive layer 312 is made of conductive materials, such as IZO or ITO transparent materials, which is located on the top surface of the photo spacer 314.

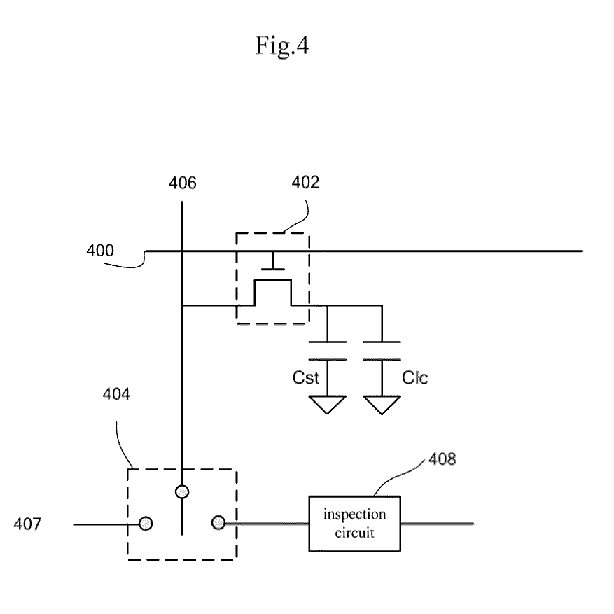

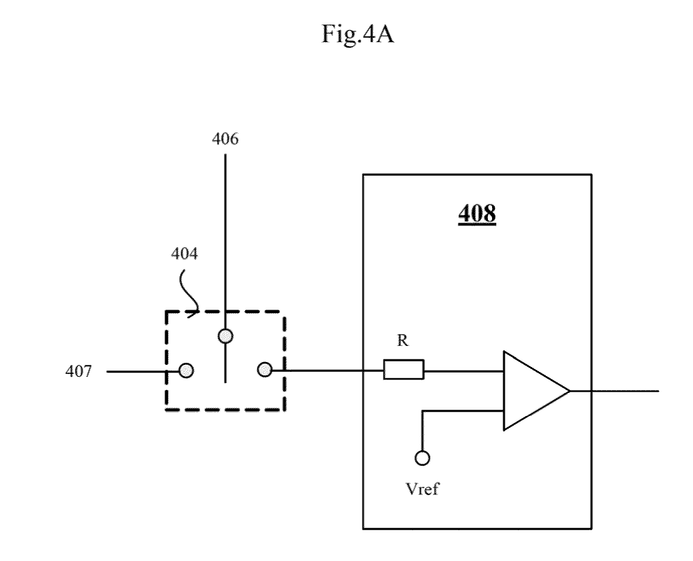

FIG. 4 is a circuit schematic diagram of implementing the press inspection and image display in the LCD panel of FIG. 3, and FIG. 4A illustrates the exemplary inspection circuit of the circuit schematic diagram of FIG. 4. The circuit structure includes a scan line 400, a TFT 402, a switch 404, a data line 406, a data driving circuit 407 and an inspection circuit 408. The gate electrode of the TFT 402 electrically connects to the scan line 400, and the source (or drain) electrode of the TFT 402 electrically connects to one terminal of the switch 404, and the drain (or source) electrode of the TFT 402 electrically connects to the pixel electrode (shown as the compensation capacitance Cst and the liquid crystal capacitance Clc in FIG. 4).

When the switch 404 is handed over, the source (or drain) electrode of the TFT 402 is electrically connected to the data driving circuit 407 through the data line 406. And the gate electrode of the TFT 402 is open and the image data is sent into the display electrode via the data line 406, to display the image. Further, when the switch 404 is handed over, the source (or drain) electrode of the TFT 402 electrically connects to the inspection circuit 408 through the data line 406, and the electrical signal from the display electrode is transmitted to the inspection circuit 408, when the display cell is pressed.

In one embodiment of the invention, we can inspect the current signal flowing through the display electrode, and generate the corresponding voltage signal by the current/voltage conversion circuit to make a comparison. In another embodiment, we can also inspect the voltage signal of the display electrode, and compare it to the reference voltage so as to determine whether the display cell is pressed.

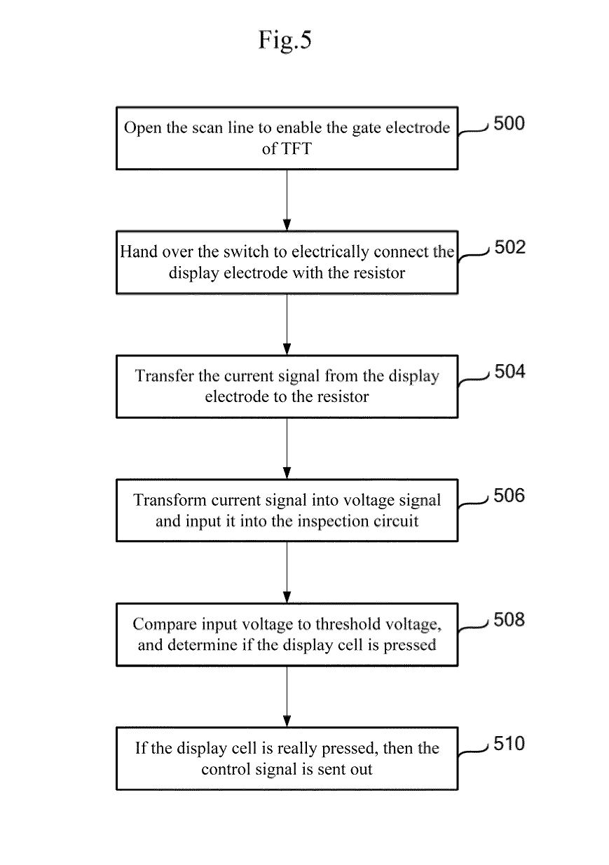

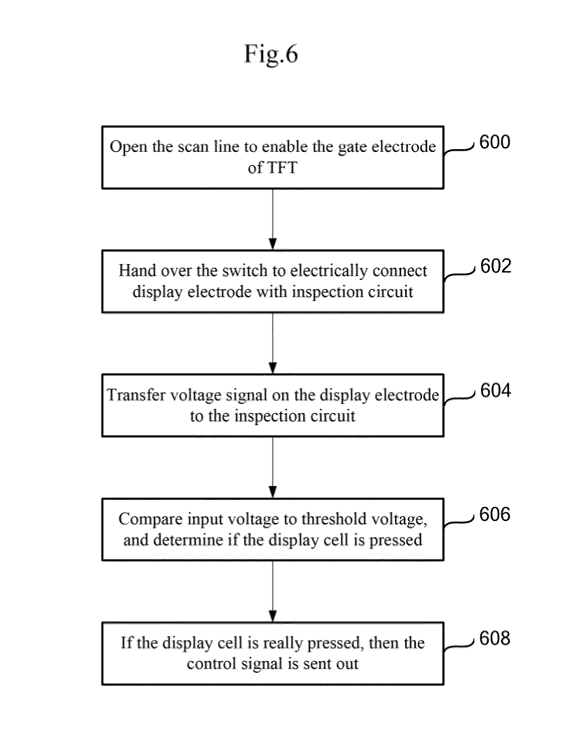

In the following description, we will illustrate in detail the inspection method of the display cells according to the inspection circuit structure in FIG. 4A. Moreover, FIG. 5 is a flow chart of a first embodiment of performing the press inspection with respect to the current signal, and FIG. 6 is a flow chart of a second embodiment of performing the press inspection with respect to the voltage signal.

In step 500, open the scan line 400, and enable the gate electrode of the TFT 402, to remain a conductive circuit path from the source electrode of the TFT 402 to the drain electrode of the TFT 402. Then, continue to execute step 502, hand over the switch 404, and connect the display electrode to the resistor via the switch. Specifically, one terminal of the switch 404 is connected to the source electrode of the TFT, and the other terminal contacts with the resistor, which is positioned before the inspection circuit 408. In step 504, the current signal flowing from the display electrode is sent into the resistor. And thereafter begin to execute the step 506. The current signal is transformed into the voltage signal and input into the inspection circuit 408. In the following step 508, compare the input voltage to the threshold voltage, to determine whether the display cell of the LCD panel is pressed or not. For example, the inspection circuit may have a voltage comparator, which is used to compare the input voltage to the threshold voltage. Specifically, with reference to the voltage comparator in FIG. 4A, a first input terminal of the voltage comparator connects to the display electrode via the switch, and a second input terminal of the voltage comparator electrically connects to a reference voltage. Preferably, the inspection circuit further comprises a resistor, disposed between the first input terminal and the switch. Finally, in step 510, if we determine that the display cell has been pressed, then the inspection circuit 408 sends out a control signal, and performs the subsequent operations.

In a similar way, the inspection method based on the voltage signal will be also described as follows. In step 600, open the scan line 400, and enable the gate electrode of the TFT 402, to remain a conductive circuit path from the source electrode of the TFT 402 to the drain electrode of the TFT 402. Then, continue to execute step 602, hand over the switch 404, and connect the display electrode to the inspection circuit via the switch. At this time, one terminal of the switch 404 is connected to the source electrode of the TFT 402, and the other terminal contacts with the inspection circuit 408. In step 604, the voltage signal of the display electrode is sent into the inspection circuit 408. And thereafter begin to execute the step 606, compare the input voltage to the threshold voltage. For example, the inspection circuit may have a voltage comparator, which is used to compare the voltage therebetween. Finally, in step 608, if we determine that the display cell has been pressed, then the inspection circuit 408 sends out a control signal, and performs the follow operations.

In the LCD panel of the present invention, a single TFT can be used to implement both the press inspection and the image display, thereby to reduce greatly the number of the readout TFTs in the LCD panel as well as improve significantly the pixel aperture ratio. In addition, the common electrode source of the LCD panel may be supplied in a DC drive mode, or may be supplied in an AC drive mode, to reduce the power consumption.

It will be understood that the above description of embodiments is given by way of example only. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A liquid crystal display (LCD) panel, comprising:
a plurality of scan lines;
a plurality of data lines, arranged to perpendicularly intersect across the scan lines;
a plurality of sense lines, arranged to be parallel to the data lines;
a plurality of pixel units, each comprising:
a display cell, electrically connected with one scan line and one data line; and
a sensor element, comprising:
a first sensing electrode;
a thin film transistor, comprising:
a gate electrode, electrically connected to the scan line connected with the display cell;
a first electrode, electrically connected to one sense line; and
a second electrode, electrically connected to the first sensing electrode;
a second sensing electrode, which is arranged on the same plane together with the first sensing electrode, and the second sensing electrode and the first sensing electrode separate from each other; and
a switch element, arranged over the first and second sensing electrodes, wherein the switch element electrically connects the first sensing electrode with the second sensing electrode when the switch element is pressed to touch the first and second sensing electrodes.

2. The liquid crystal display panel according to claim 1, wherein the switch element is a conductive material layer disposed on the top surface of a photo spacer and the photo spacer is disposed on a first substrate opposite to a second substrate having the thin film transistor thereon.

3. The liquid crystal display panel according to claim 1, wherein the second sensing electrode electrically connects to a storage capacitance bottom electrode or a next scan line adjacent to the sensor element.

4. The liquid crystal display panel according to claim 2, wherein the conductive material layer is a transparent material of ITO or IZO.

5. The liquid crystal display panel according to claim 2, wherein the conductive material layer is electrically insulated to a common electrode disposed on the first substrate.

6. The liquid crystal display panel according to claim 1, wherein the first sensing electrode is a low-level voltage when the switch is pressed down.

7. A liquid crystal display (LCD) panel, comprising:
a plurality of scan lines;
a plurality of data lines, arranged to perpendicularly intersect across the scan lines;
a plurality of display pixel cells, each comprising:
a sensing bottom electrode, electrically connected to a reference power source;
a display electrode, arranged on the same plane together with the sensing bottom electrode, and the display electrode and the sensing bottom electrode separate from each other;
a thin film transistor, comprising:
a gate electrode, electrically connected to one scan line;
a first electrode, electrically connected to one data line; and
a second electrode, electrically connected to the display electrode; and
a sensing conductive layer, disposed over the sensing bottom electrode and the display electrode, wherein the sensing conductive layer electrically connects the sensing bottom electrode and display electrode when the sensing conductive layer is pressed down to touch the sensing bottom electrode and display electrode;
an inspection circuit for inspecting the voltage of the display electrode; and
a switch, electrically connecting to the data line for handing over the first electrode electrically connecting to the inspection circuit through the data line, and when the display signal is written into the display electrode, the switch connects the first electrode with a data driving circuit.

8. The liquid crystal display panel according to claim 7, wherein the sensing conductive layer is made of transparent conductive materials.

9. The liquid crystal display panel according to claim 8, wherein the transparent conductive material is ITO or IZO.

10. The liquid crystal display panel according to claim 7, wherein the sensing conductive layer is located on the top surface of a photo spacer and the photo spacer is disposed on a first substrate opposite to a second substrate having the thin film transistor thereon.

11. The liquid crystal display panel according to claim 10, wherein the sensing conductive layer is insulated to a common electrode disposed on the first substrate.

12. The liquid crystal display panel according to claim 7, wherein the display electrode is the reference voltage level when the sensing conductive layer is pressed down.

13. The liquid crystal display panel according to claim 7, wherein the inspection circuit comprises a voltage comparator.

14. The liquid crystal display panel according to claim 13, wherein a first input terminal of the voltage comparator connects to the display electrode via the switch, and a second input terminal of the voltage comparator electrically connects to a reference voltage.

15. The liquid crystal display panel according to claim 14, wherein the inspection circuit further comprises a resistor, disposed between the first input terminal and the switch.

16. The liquid crystal display panel according to claim 7, further comprising a resistor arranged between the inspection circuit and the switch.

17. An inspection method for the liquid crystal display panel as claimed in claim 16, the method comprising:
opening the scan line linking to the gate electrode, and handing over the switch to connect the display electrode with the inspection circuit; and
transmitting electrical signal of the display electrode to the inspection circuit,
wherein the inspection circuit sends out a control signal representing that the display cell has been pressed and the sensing conductive layer electrically connects the display electrode to the sensing bottom electrode, when the electrical signal of the display electrode is derived from the reference power source.

18. The inspection method according to claim 17, wherein the electrical signal is a current signal.

19. An inspection method for touching the liquid crystal display panel as claimed in claim 7, the method comprising:
opening the scan line linking to the gate electrode, and handing over the switch to connect the display electrode with the inspection circuit; and
transmitting a voltage signal of the display electrode to the inspection circuit,
wherein the inspection circuit sends out a control signal representing that the display cell has been pressed and the sensing conductive layer electrically connects the display electrode to the sensing bottom electrode, when the voltage signal of the display bottom electrode is derived from the reference power source.
